(19) United States
(12) Patent Application Publication
(10) Pub. No.: US 2012/0180888 A1
(43) Pub. Date: Jul. 19, 2012

(54) HIGH FLOW SERVICE VALVE

(75) Inventor: Thomas Clifford Trent, Fort Wayne, IN (US)

(73) Assignee: PARKER HANNIFIN CORPORATION, CLEVELAND, OH (US)

(21) Appl. No.: 13/498,184

(22) PCT Filed: Oct. 15, 2010
(86) PCT No.: PCT/US10/52780

§ 371 Date: Mar. 26, 2012

Related U.S. Application Data
(60) Provisional application No. 61/251,765, filed on Oct. 15, 2009.

(51) Int. Cl. F16K 11/20; B23P 11/00

(52) U.S. Cl. 137/614.18; 29/428

(57) ABSTRACT

A high flow service valve is provided that does not rely on the use of a valve core. The high flow service valve allows a condensing unit to be evacuated and charged very quickly. The high flow service valve utilizes a second movable obturator positioned at least partially in the valve body having a first position wherein a charge passageway is fluidly connected to a charge port and a second position wherein the charge passageway is fluidly disconnected from the charge port.

### CROSS REFERENCE TO RELATED APPLICATIONS

The present application is a National Stage application of PCT Application No. PCT/US2010/052780 filed on Oct. 15, 2010 to which this application claims priority and the benefit of U.S. Provisional Application No. 61/251,765, filed on Oct. 15, 2009, the disclosure of which is also hereby incorporated by reference in its entirety.

### TECHNICAL FIELD

The present invention relates, in general, to a service valve of the type used on air conditioning and heat pumps.

### BACKGROUND

Service valves are used in refrigerant systems to conveniently, add and remove refrigerant. Referring to FIG. 1, a common type of service valve is the front-seat valve 730. An example of such a valve is shown in U.S. Pat. No. 4,644,973 to Itoh et al. Front seat valve 730 contains a charge port 735 through which the installation/service technician can gage the system pressure, evacuate the system, or add refrigerant charge to the system. Front seat valve 730 has an obturator 740 that seals against a front seat 744 of valve body 732. Charge port 735 is equipped with a valve core 737, which prevents refrigerant from escaping charge port 735 until a stem 738 of valve core 737 is depressed by the service hose connection. Valve core 737 is sealed with elastomeric seals which can lose their sealing characteristics over time. When connected to a service hose, a flow path through charge port 735 is opened and the system can be accessed. The volumetric flow rate of gas, into or out of the system, is restricted by this generally small flow path. Therefore, the time required to service the system is negatively increased due to the size.

There have been many attempts in the prior art to improve the front-seat valve design but these efforts have all resulted in complex valves that are difficult to manufacture and are susceptible to failure.

### SUMMARY

At least one embodiment of the invention provides a service valve comprising: a valve body having an inlet, a first outlet, and a charge passageway leading to a charge port; a first movable obturator positioned at least partially in the valve body having a first position wherein the inlet is fluidly connected to the first outlet and a second position wherein the inlet is fluidly connected to the charge passageway and the inlet is fluidly disconnected from the first outlet; a second movable obturator positioned at least partially in the valve body having a first position wherein the charge passageway is fluidly connected to the charge port and a second position wherein the charge passageway is fluidly disconnected from the charge port.

At least one embodiment of the invention provides a service valve comprising: a service valve comprising: a valve body having an inlet, a first outlet, and a charge passageway leading to a charge port; a first movable obturator positioned at least partially in a first valve body having a first position wherein the inlet is fluidly connected to the first outlet and a second position wherein the inlet is fluidly connected to the charge passageway and the inlet is fluidly disconnected from the first outlet; a second movable obturator positioned at least partially a second valve body attached to the first valve body to form the charge passageway, the second obturator having a first position wherein the charge passageway is fluidly connected to the charge port and a second position wherein the charge passageway is fluidly disconnected from the charge port.

At least one embodiment of the invention provides a method of providing a service port to a valve, the method comprising: providing a valve having a first moveable obturator to block and unblock flow between an inlet and an outlet of the valve; attaching a second valve at a position on the first valve wherein the second valve can be fluidly connected to one of the inlet or the outlet of the first valve when the flow between the inlet and the outlet of the first valve is blocked by the first obturator; opening and closing a second obturator in the second valve which fluidly connects and disconnects a charge port of the second valve to the one of the inlet or the outlet of the first valve.

### BRIEF DESCRIPTION OF THE DRAWINGS

Embodiments of this invention will now be described in further detail with reference to the accompanying drawings, in which:

FIG. 1 is a cross-sectional view of a prior art front-seat service valve;

FIG. 2 is a perspective view of an embodiment of the high-flow port for valves in accordance with a the present invention;

FIG. 3 is a perspective view of the high-flow port for valves of FIG. 2 shown with the connecting port in an up position;

FIG. 4 is a view of the high-flow port for valves of FIG. 2 shown with the connecting port in an up position;

FIG. 5 is a side view of the high-flow port for valves of FIG. 2 shown with the connecting port in an up position;

FIG. 6 is a cross-sectional view of the valve as depicted in FIG. 5 with an open high-flow connecting port;

FIG. 7 is a cross-sectional view of the valve as depicted in FIG. 5 with a closed high-flow connecting port;

FIG. 8 is a cross-sectional view of another embodiment of the present invention showing a flare valve having a high-flow connecting port;

FIG. 9 is a cross-sectional view of another embodiment of the present invention showing a globe valve having a high-flow connecting port;

FIG. 10 is a partial cross-sectional view of another embodiment of the present invention showing a ball valve having a high-flow connecting port; and

FIG. 11 is a partial cross-sectional view of the valve of FIG. 10 showing the high-flow connecting port.

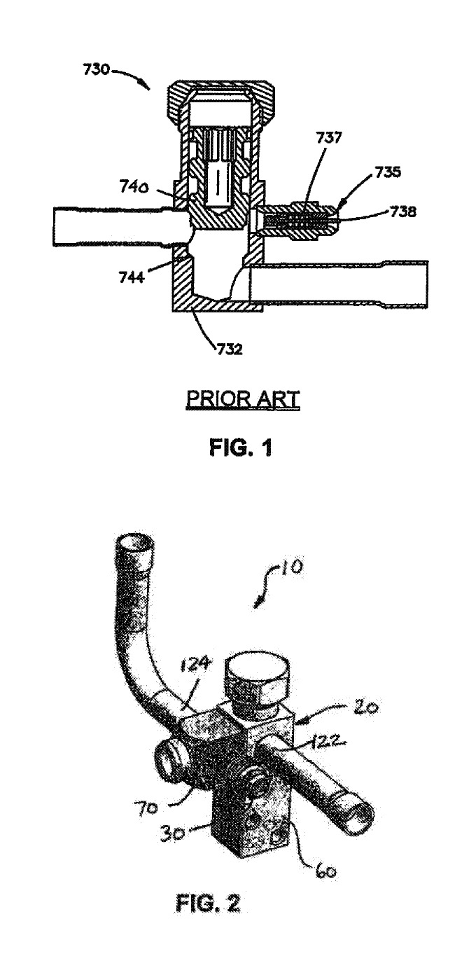

### DETAILED DESCRIPTION OF THE DRAWINGS

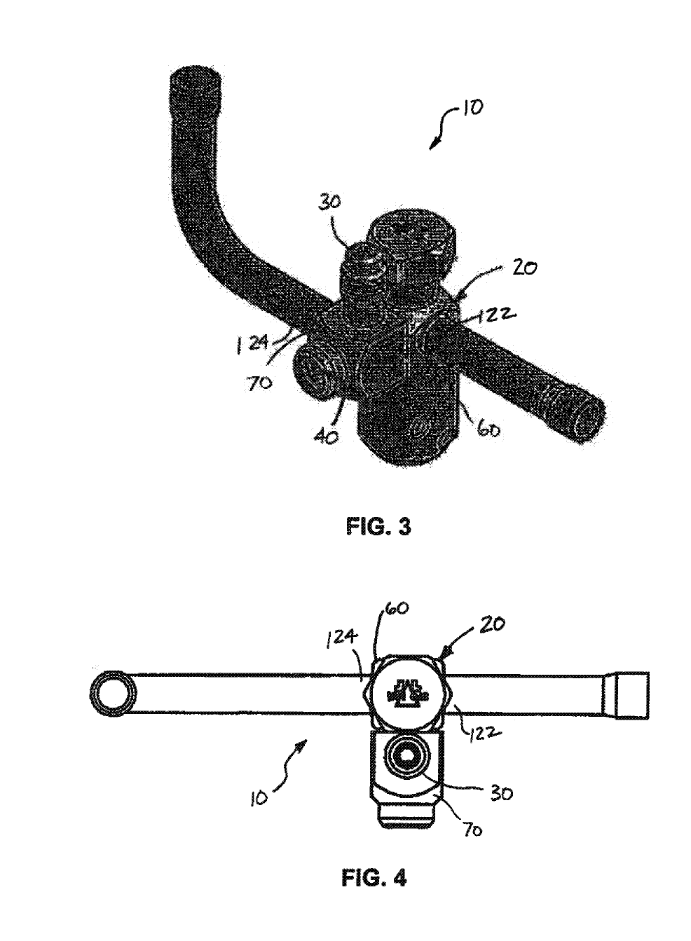

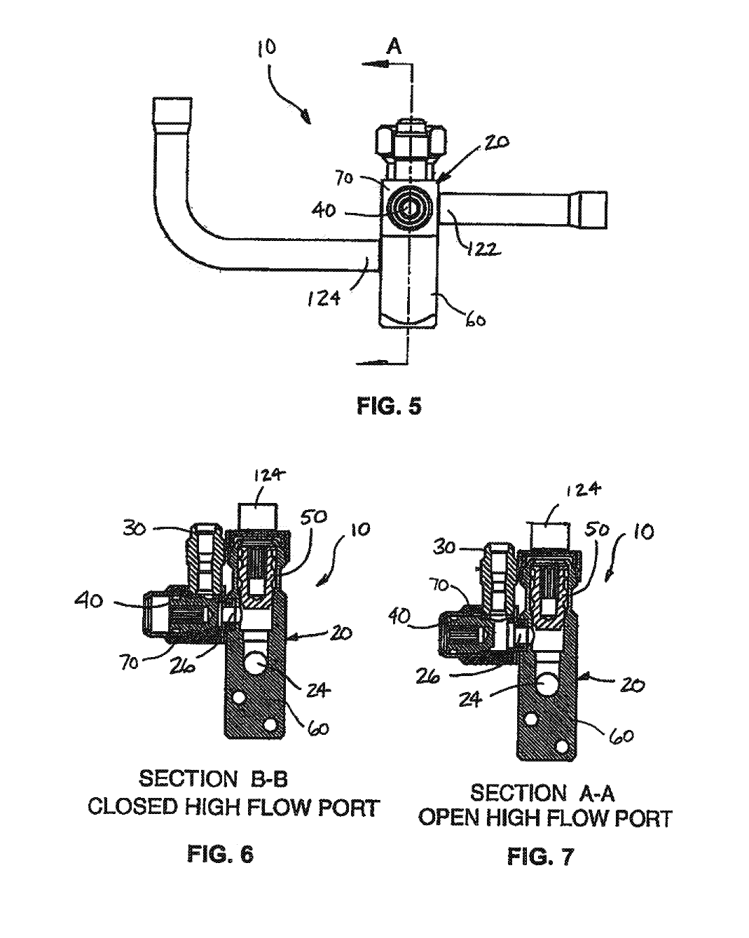

Referring now to FIGS. 2-7, an embodiment of a service valve 10 in accordance with the present invention is shown in various views and cross-sections showing the operation of the valve 10. The service valve 10 comprises a valve body 20 having an inlet 22 and inlet tube 122, a first outlet 24 and outlet tube 124, and a charge passageway 26 leading to a charge port 30. The valve 10 includes a first movable obturator 40 positioned at least partially in the valve body 20 having a first position wherein the first obturator 40 allows a fluid connection between the inlet 22 and the first outlet 24 (as shown in FIG. 6) and a second position wherein the first obturator 40 allows a fluid connection between the inlet 22 and the charge passageway 26 while preventing a fluid connection with the first outlet 24 (not shown). A second movable obturator 50 is positioned at least partially in the valve body 20 having a first position wherein the second obturator 50 prevents a fluid connection between the charge passageway 26 to the charge port 30 (as shown in FIG. 6) and a second position allowing a fluid connection between the charge passageway 26 and the charge port 30 (as shown in FIG. 7). The moveable obturators 40, 50 are typically moveable by threaded means that are well known in the industry.

The valve body 20 may be constructed in more than one part for ease of assembly and the reduction of the cost to produce the valve 10. As best shown in FIGS. 6 and 7, the housing 20 is formed by two connected parts 60 and 70. The first obturator 40 is positioned at least partially in the first part 60 of the valve body 20 and the second obturator 50 is positioned at least partially in the second part 70 of the valve body 20. The first part 60 of the valve body 20 includes the inlet 22 and the first outlet 24. The second part 70 of the valve body 20 includes the charge port 30. The second part 70 is attached to the first part 60 to form the charge passageway 26.

The service valve 10 is operated during normal use with the first obturator 40 and the second obturator 50 as shown in FIG. 6 wherein the fluid flows from the inlet 22 to the first outlet 24. During a service, the flow to the first outlet is stopped by moving the first obturator 40 downward to close the first outlet 24 (not shown). The second obturator 50 is only moved to allow a fluid connection between the charge passageway 26 and the charge port 30 when a proper system fitting is attached to the charge port 30. When the system fitting is to be removed from the charge port 30, the second obturator 50 is moved to close the fluid connection between the charge passageway 26 and the charge port 30 and then the system fitting can be safely removed from the charge port 30. The first obturator 40 is moved upward to open the fluid connection between the inlet 22 and the first outlet 24 as shown in FIG. 6.

The present invention also provides a method of providing a service port to a valve. The method comprises the steps of 1) providing a valve having a first moveable obturator to block and unblock flow between an inlet and an outlet of the valve; 2) attaching a second valve at a position on the first valve Wherein the second valve can be fluidly connected to one of the inlet or the outlet of the first valve when the flow between the inlet and the outlet of the first valve is blocked by the first obturator; 3) opening and closing a second obturator in the second valve which fluidly connects and disconnects a charge port of the second valve to the one of the inlet or the outlet of the first valve.

It is noted that by using the concept of the present invention, the user is able to do away with the valve core, a tremendous restrictor of flow, and may evacuate and charge a condensing unit very quickly.

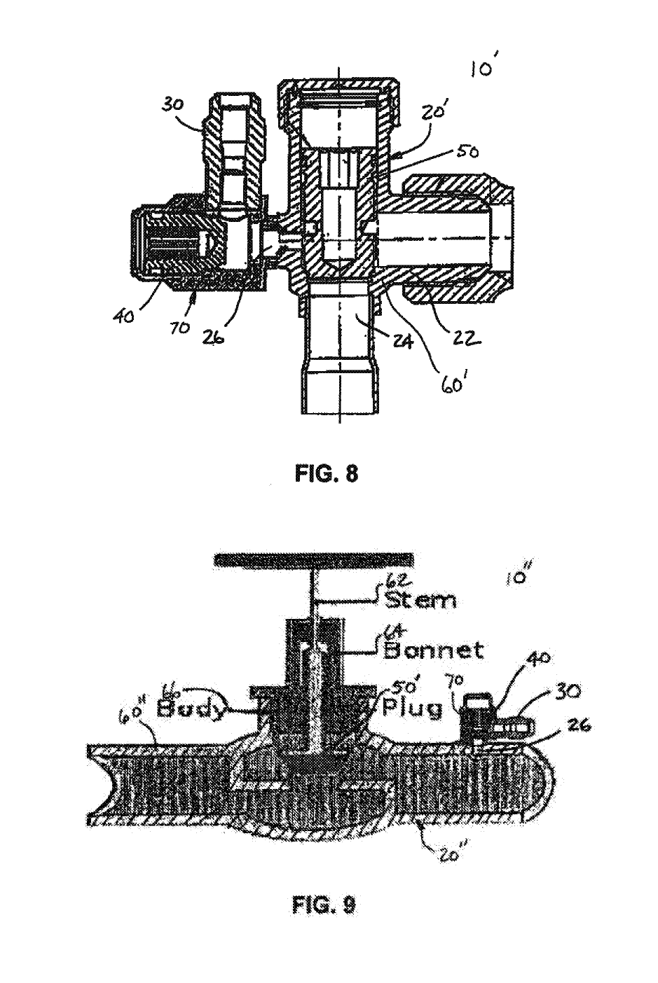

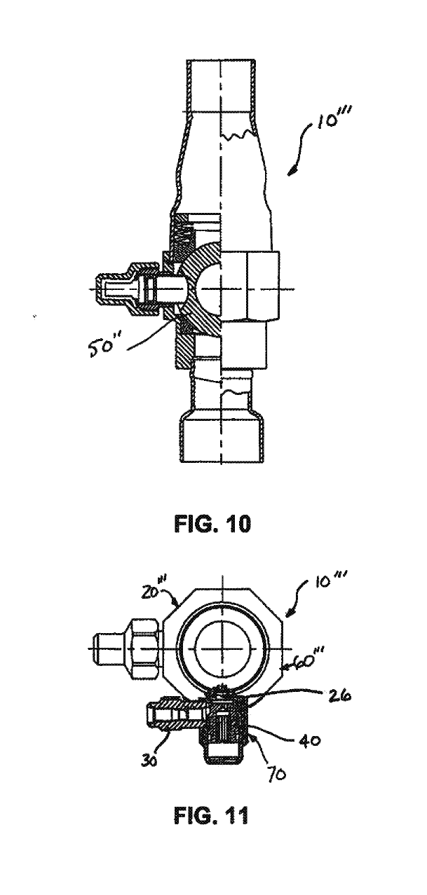

The high flow aspect of the valve can be used with different types of valves than the z-flow service valve. In FIG. 8 a high flow service flare valve 10′ is shown. As with the previous embodiment, the second part 70 of the valve body 20′ includes the charge port 30. The second part 70 is attached to the first part 60′ to form the charge passageway 26. In FIG. 9 a high flow service globe valve 10″ is shown. The globe valve 10″ includes a stem 62, bonnet 64, stem body 66 and obturator 50′ in the form of a plug. As with the previous embodiment, the second part 70 of the valve body 20″ includes the charge port 30. The second part 70 is attached to the first part 60″ to form the charge passageway 26. In FIGS. 10 and 11 a high flow service ball valve 10″ is shown. The ball valve 10″′ includes an obturator 50″ in the form of a ball. As with the previous embodiment, the second part 70 of the valve body 20″′ includes the charge port 30. The second part 70 is attached to the first part 60″′ to form the charge passageway 26.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A service valve comprising:
a valve body having an inlet, a first outlet, and a charge passageway leading to a charge port;
a first movable obturator positioned at least partially in the valve body having a first position wherein the inlet is fluidly connected to the first outlet and a second position wherein the inlet is fluidly connected to the charge passageway and the inlet is fluidly disconnected from the first outlet;
a second movable obturator positioned at least partially in the valve body having a first position wherein the charge passageway is fluidly connected to the charge port and a second position wherein the charge passageway is fluidly disconnected from the charge port.

2. The service valve of claim 1, wherein the valve body is formed in two parts.

3. The service valve of claim 2, wherein the first obturator is positioned at least partially in a first part of the valve body and the second obturator is positioned at least partially in a second part of the valve body.

4. The service valve of claim 3, wherein the inlet and the first outlet are positioned in the first part of the valve body, the service port is attached to the second part of the valve body, and the first part of the valve body is attached to the second part of the valve body at the charge passageway.

5. The service valve of claim 1, wherein the charge port is not obstructed by a valve core.

6. The service valve of claim 3, wherein the first part of the valve body is a z-flow valve.

7. The service valve of claim 3, wherein the first part of the valve body is a flare valve.

8. The service valve of claim 3, wherein the first part of the valve body is a globe valve.

9. The service valve of claim 3, wherein the first part of the valve body is a ball valve.

10. A service valve comprising:
a valve body having an inlet, a first outlet, and a charge passageway leading to a charge port;
a first movable obturator positioned at least partially in a first valve body having a first position wherein the inlet is fluidly connected to the first outlet and a second position wherein the inlet is fluidly connected to the charge passageway and the inlet is fluidly disconnected from the first outlet;
a second movable obturator positioned at least partially a second valve body attached to the first valve body to form the charge passageway, the second obturator having a first position wherein the charge passageway is fluidly connected to the charge port and a second position wherein the charge passageway is fluidly disconnected from the charge port.

11. The service valve of claim 10, wherein the charge port is not obstructed by a valve core.

12. The service valve of claim 10, wherein the first valve body is a z-flow valve.

13. The service valve of claim 10, wherein the first valve body is a flare valve.

14. The service valve of claim 10, wherein the first valve body is a globe valve.

15. The service valve of claim 10, wherein the first valve body is a ball valve.

16. A method of providing a service port to a valve, the method comprising:
providing a valve having a first moveable obturator to block and unblock flow between an inlet and an outlet of the valve;
attaching a second valve at a position on the first valve wherein the second valve can be fluidly connected to one of the inlet or the outlet of the first valve when the flow between the inlet and the outlet of the first valve is blocked by the first obturator;
opening and closing a second obturator in the second valve which fluidly connects and disconnects a charge port of the second valve to the one of the inlet or the outlet of the first valve.
